(19) United States
(12) Patent Application Publication
(10) Pub. No.: US 2006/0129531 A1
(43) Pub. Date: Jun. 15, 2006

(54) Method and system for suggesting search engine keywords

(75) Inventor: Cary Lee Bates, Rochester, MN (US)

Correspondence Address: WOOD, HERRON & EVANS, L.L.P. (IBM), 2700 CAREW TOWER, 441 VINE STREET, CINCINNATI, OH, 45202, US

(73) Assignee: International Business Machines Corporation, Armonk, NY (US)

(21) Appl. No.: 11/008,807

(22) Filed: Dec. 9, 2004

(51) Int. Cl. G06F 17/30

(52) U.S. Cl. 707/3

(57) ABSTRACT

A search engine receives a search query having one or more keywords. The documents in the result set from that search query are analyzed to identify one or more additional keywords that further segment, or separate, the initial result set. These additional keywords are presented to the user who then selects whether to include or exclude documents matching the additional keywords. In this way, the number of documents in the initial result set is reduced in a relatively quick and effortless manner.

### FIELD OF THE INVENTION

The present invention relates generally to searching electronic information and, more particularly, to generating a result set in response to a query.

### BACKGROUND OF THE INVENTION

As more and more information is created and stored in electronic format, and as legacy paper documents are converted into electronic format, finding relevant data among this increasingly large body of information becomes increasingly difficult. The volume of information accessible via the Internet, for example, continues to grow at an exponential rate. Furthermore, as storage technologies have improved in capacity and performance, the amount of information that may be stored on a user computer, or otherwise made accessible via a local network, also continues to increase.

To assist users in finding relevant data among these large bodies of information, programs or services referred to as search engines have been developed to generate in response to a user query a “result set” of documents, records, or other information that most closely matches the user's query. Significant efforts have been directed toward improving the search algorithms and methodologies utilized by search engines similar programs/services, predominantly driven by the increase in the volume of information and the resulting increase in difficulty in paring down potential matching data to that data most likely to satisfy a user's query.

In many cases, however, a basic impediment to the ability of a search engine to generate an optimal result set is the initial quality of the query input by a user. Many search engines support a complex query language that enables skilled users to accurately focus as query on desired information. However, the amount of skill required to generate complex queries in this manner often exceeds the abilities of many users, and as a consequence, many users are unable to take advantage of advanced query formulation techniques to properly focus their queries to retrieve the best information. Indeed, the limited level of skill of the typical users of many search engines presents a competing concern for search engine designers, as accommodation for such users typically requires that the manner in which queries are entered be as simple as possible.

For example, many search engines utilized to search information on the Internet, where it must be assumed that the level of skill of the typical user is relatively low, rely on simple keyword searching, where users simply enter one or more keywords and/or phrases that describe the information they are looking for. However, in many instances, simple keyword searching initially returns a large number of matching documents, and often requires a user to enter additional keywords to narrow down the search to a more manageable result set. Determining what keywords would be most useful in paring down the search results is often left to the user, and can either result in insufficient narrowing, or narrowing in a manner that excludes potentially relevant information.

To address some of these concerns, some search engines automatically include synonyms for the specific words entered in a search query or suggest alternative spellings for keywords that are apparently misspelled. Even with such capabilities, however, search queries involving common terms often produce result sets having thousands or tens of thousands of matching documents. Even more focused search queries sometimes return hundreds of matching documents in the search results. This amount of information is typically too large to be useful as searching through each individual document is prohibitively time consuming. As a result, some relevant documents may be missed by a user when scanning through a large number of irrelevant documents.

Accordingly, a continuing and unmet need exists for improving the manner in which a search engine generates results in response to user queries.

### SUMMARY OF THE INVENTION

The invention addresses these and other problems associated with the prior art by attempting to narrow down a result set generated in response to a query by analyzing the result set to identify one or more additional keywords that, when applied to the result set, would serve to narrow down the result set and improve upon the initial query.

While other embodiments are contemplated, one exemplary embodiment of the invention may attempt to identify and suggest to a user an additional keyword that serves to effectively bifurcate a result set into two similarly sized subsets, such that the user can choose to eliminate one of the subsets simply through including or excluding that additional keyword, and thus effectively reduce the size of the result set in half. Moreover, by iterating through the process multiple times, and including or excluding multiple additional keywords, a user may be able to pare the result set down to a more manageable size in a relatively quick and effortless manner.

Consistent with one aspect of the invention, for example, a search is performed in response to a query that includes one or more keywords. In response to the query, a result set is generated that identifies a plurality of results. The result set is analyzed to identify at least one additional keyword missing from the query that would narrow the result set, and the result set is narrowed based upon the additional keyword.

Consistent with another aspect of the invention, a search is performed by receiving a search query comprising one or more keywords, returning search results that identify a plurality of web pages by executing the search query, analyzing the search results to identify an additional keyword missing from the one or more keywords, and narrowing the number of web pages identified by search results based on the additional keyword.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a networked computer system incorporating a search engine consistent with the principles of the present invention.

FIG. 2 is a flowchart of an exemplary algorithm for modifying search results in accordance with the principles of the present invention.

FIG. 3 is a block diagram of computer display, illustrating an exemplary search results window that displays both a portion of a result set and pruning keyword as may be suggested by the algorithm of FIG. 2.

### DETAILED DESCRIPTION

As mentioned above, the embodiments discussed hereinafter utilize a search engine or similar program or service that analyzes an initial result set to suggest additional keywords that a user may use to modify the search results, and as a result, enable a user to pare down, or “prune” the search results to a smaller, and more focused number. A specific implementation of such a search engine capable of supporting this functionality in a manner consistent with the invention will be discussed in greater detail below. However, prior to a discussion of such a specific implementation, a brief discussion will be provided regarding an exemplary hardware and software environment within which such a search engine framework may reside.

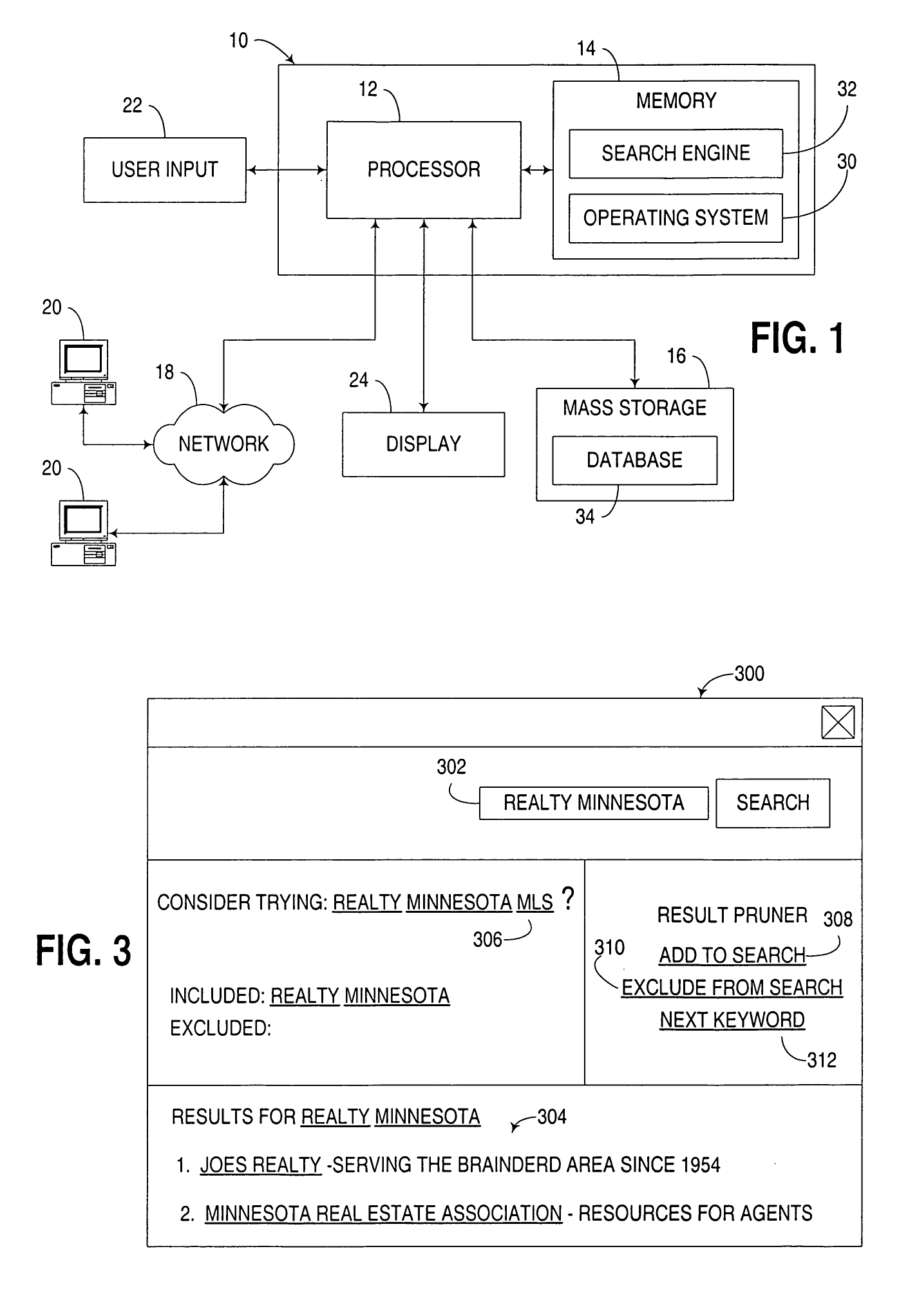

Turning now to the Drawings, wherein like numbers denote like parts throughout the several views, FIG. 1 illustrates an exemplary hardware and software environment for an apparatus 10 suitable for implementing a search engine system that permits users to be automatically provided with suggested keywords for improving the search results. For the purposes of the invention, apparatus 10 may represent practically any type of computer, computer system or other programmable electronic device, including a client computer, a server computer, a portable computer, a handheld computer, an embedded controller, etc. Moreover, apparatus 10 may be implemented using one or more networked computers, e.g., in a cluster or other distributed computing system. Apparatus 10 will hereinafter also be referred to as a “computer”, although it should be appreciated the term “apparatus” may also include other suitable programmable electronic devices consistent with the invention.

Computer 10 typically includes at least one processor 12 coupled to a memory 14. Processor 12 may represent one or more processors (e.g., microprocessors), and memory 14 may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 14 may be considered to include memory storage physically located elsewhere in computer 10, e.g., any cache memory in a processor 12, as well as any storage capacity used as a virtual memory, e.g., as stored on a mass storage device 16 or on another computer coupled to computer 10 via network 18 (e.g., a client computer 20).

Computer 10 also typically receives a number of inputs and outputs for communicating information externally. For interface with a user or operator, computer 10 typically includes one or more user input devices 22 (e.g., a keyboard, a mouse, a trackball, a joystick, a touchpad, and/or a microphone, among others) and a display 24 (e.g., a CRT monitor, an LCD display panel, and/or a speaker, among others). Otherwise, user input may be received via another computer (e.g., a computer 20) interfaced with computer 10 over network 18, or via a dedicated workstation interface or the like.

For additional storage, computer 10 may also include one or more mass storage devices 16, e.g., a floppy or other removable disk drive, a hard disk drive, a direct access storage device (DASD), an optical drive (e.g., a CD drive, a DVD drive, etc.), and/or a tape drive, among others. Furthermore, computer 10 may include an interface with one or more networks 18 (e.g., a LAN, a WAN, a wireless network, and/or the Internet, among others) to permit the communication of information with other computers coupled to the network. It should be appreciated that computer 10 typically includes suitable analog and/or digital interfaces between processor 12 and each of components 14, 16, 18, 22 and 24 as is well known in the art.

Computer 10 operates under the control of an operating system 30, and executes or otherwise relies upon various computer software applications, components, programs, objects, modules, data structures, etc. (e.g., search engine 32 and database 34, among others). Moreover, various applications, components, programs, objects, modules, etc. may also execute on one or more processors in another computer coupled to computer 10 via a network 18, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

A particular embodiment of the present invention may be described with reference to FIG. 1. A user on a client computer 20 connects with a computer system 10 that runs a search engine application 32. The search engine application 32 has access to a database 34 in mass storage 16, e.g., a database of indexed web pages, or other data repository. From this storage 16, the search engine 32 can retrieve query results for providing to the user 20. It should be noted that, for example, if search engine 32 is a web or Internet search engine, database 34 will typically store an index of a portion of the web pages accessible via the Internet, as is well known in the art. If used to search private data, e.g., on a user's desktop computer, or even data resident on a private network, database 34 may store an index of such data. Alternatively, the search engine may not rely on an index, but may search a body of information directly, e.g., in a DBMS environment, or a file system environment. It should also be appreciated that the term “search engine” is used herein merely for convenience, and that practically any program that executes a search to generate a result set from a body of information can implement the functionality described herein.

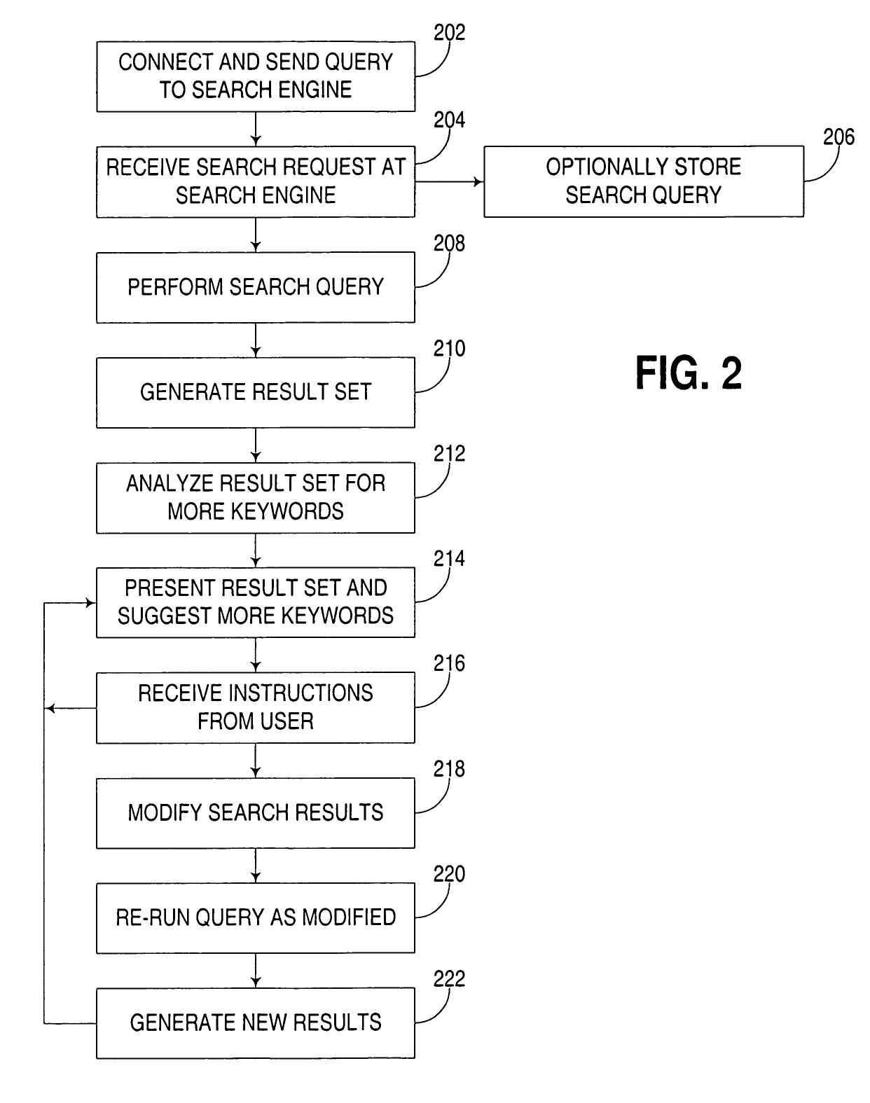

The flowchart of FIG. 2 illustrates an exemplary method for modifying a search query in accordance with the principles of the present invention. This exemplary method specifically relates to performing a search over the web using a search engine. It will be appreciated, however, that the present invention contemplates searching any body of electronic information sources that are indexed according to keywords or other identifiers.

In step 202, a user on a computer connected to a network, such as the Internet, connects with a search engine application available through the network connection. Such a connection will typically be accomplished using a web browser to access a search engine. As known, search engines routinely traverse the web indexing the available information sources according to content so that a search query may be run against those indices. However, in accordance with the principles of the present invention, the present search engine has been modified to provide help in selecting additional keywords.

In step 204, the search engine receives from the user a search query. The query includes various phrases and words relating to information which the user is searching for; these words are typically referred to as keywords. The query may also include other conditions, e.g., date or domain restrictions, desired omitted keywords, or other conditions known in the art. As shown in step 206, the search engine may optionally store the search query in order to have historical data that may be used for further analysis if desired.

Once the search query is received, the search engine performs the query in step 208. Performance of the query involves searching through the available indices to locate results, e.g., web pages, that match the criteria of the search query. Next, in step 210, a result set is generated by the search engine.

In step 212, the search engine analyzes the web pages that are returned in the search results. In particular, the search engine identifies one or more additional keywords (typically keywords missing from the original query) that are associated with each of the returned web pages, and that may be interesting from the standpoint of being capable of partitioning, or “pruning” the search results into two groups based upon the addition of the keywords to the query.

In many embodiments, it is desirable to attempt to locate an additional keyword that bifurcates or partitions a result set into roughly equally sized groups: a first group of results that match the additional keyword, and a second group of results that do not match the additional keyword, whereby each group represents roughly 50% of the overall result set. By doing so, the ability to rapidly prune the search results down is maximized, irrespective of whether the user ultimately chooses to select those search results that match or do not match the keyword.

For example, if 25% of the returned web pages for a particular query included a particular keyword, paring down the result set to include only those web pages that match the keyword would reduce the result set to only ¼th its original size. However, if the user wished to pare the result set down to include only those pages that did not match the keyword would only reduce the result set by a relatively smaller amount, as 75% of the original result set would still remain. In contrast, were another keyword found to be in roughly 50% of the web pages for the same query, the result set could potentially be reduced by roughly 50% regardless of whether the user chose those web pages that did or did not match the keyword. Thus, for example, if a search for “Minnesota AND realty” was performed, and the search engine determined that nearly 50% of the returned web pages also included the term “MLS”, the result set could be pared down by a factor of two irrespective of whether the user was interested in viewing web pages including the additional term.

Thus in step 212, the search engine analyzes the returned web pages to determine one or more additional keywords that separate or partition the original result set. In the above example, if “MLS” was added as an additional keyword to “Minnesota AND realty”, then nearly 50% of the initial result set could be pruned away. Similarly, if a search query for “lighter AND air” was performed, the search engine may determine that 60% of the results matched the word “cigarette”. If a user was interested in hot-air balloons and not cigarette lighters, then excluding from the result set those web pages not matching the term “cigarette” would reduce the result set by nearly 60%.

The present invention contemplates a variety of different analysis techniques to determine which keywords help separate the initial result set. For example, the search engine may determine that only keywords that occur in approximately 50% (e.g., 50±15%, or desirably between about 40% and about 60%) of the results adequately separate the initial result set. Alternatively, the search engine may utilize historical data to determine which additional search terms have historically been included with the initial query keywords. In one advantageous embodiment, the percentage of occurrence and historical data may be combined in a relatively simple formula:
Score=[ABS (P-50%)]−F
where P is the percentage of pages in which the additional keyword is present, and F is a factor indicating how often the additional keyword is included in queries such as the initial search query.

According to this formula, the lower the score, the more likely the additional keyword will differentiate or separate the initial result set. The search engine may locate all keywords that score below a certain threshold as potential additional keywords to use to modify the initial search query. These keywords may then be presented to the user one at a time or in a ranked list.

Once one or more additional keywords have been identified, in step 214, the search engine outputs at least a portion of the search results (e.g., the first X results) and also suggests one or more additional keywords which the user might consider to use to modify the initial search query. The user then provides, in step 216, instructions to a) include the additional keyword in the search query, b) exclude documents matching the additional keyword from the search query, c) ignore this particular keyword, or d) simply view the existing search results.

If the user ignores the keyword, then the next identified keyword may be presented to the user and instructions may once again be received in step 216 on how to proceed. If the user wants to modify the search results, in step 218, based on the keyword, then, in step 220, the search engine may re-run the search query as modified. The new results are generated in step 222 and the user is returned to step 214 and eventually given the option to revise the search results once again.

As one alternative to sequentially providing each suggested keyword to a user, a list of all the additional keywords or the top n keywords may be presented to the user along with an interface screen. Within this interface screen, the user may then indicate whether each keyword should be included, excluded, or ignored. After receiving these instructions, the search engine may re-run the search query as modified. Additionally, when determining the “next” keyword, the user's browser may individually contact the search engine each time or the entire list of keywords may be returned as part of a Javascript so that the browser does not need to return to the search engine to retrieve each keyword.

As an example of one manner of presenting search results to a user in a manner consistent with the invention, FIG. 3 illustrates a search results window 300 that displays a query 302 (“realty Brainerd Minnesota”) and a portion of a result set 304 that matches the query. Furthermore, the window displays a suggested additional keyword 306 (“MLS”) as well as three hyperlinks 308, 310, 312, which respectively permit the user to include the additional keyword in the search and rerun the query, exclude the additional keyword from the search and rerun the query, or ignore the additional keyword and view another suggested keyword.

Accordingly, a system and method has been described that permits automatic identification of additional keywords that may be used to improve the selectivity of a search query to improve the relevance of the members of the result set. Various modifications may be made to the illustrated embodiments without departing from the spirit and scope of the invention. Therefore, the invention lies in the claims hereinafter appended.

What is claimed is:

1. A computer-implemented method for performing a search, the method comprising the steps of:
in response to a query that includes one or more keywords, generating a result set identifying a plurality of results that match the query;
analyzing the result set to identify at least one additional keyword missing from the query that would narrow the result set; and
narrowing the result set based upon the additional keyword.

2. The method of claim 1, further comprising the step of:
removing from the result set those results matching the additional keyword.

3. The method of claim 1, further comprising the step of:
removing from the result set those results not matching the additional keyword.

4. The method of claim 1, wherein the additional keyword matches a first portion of the results and does not match a second portion of the results.

5. The method of claim 4, wherein the first portion is approximately 50%.

6. The method of claim 4, wherein the second portion is approximately 50%.

7. The method of claim 1, further comprising the steps of:
outputting at least a portion of the result set;
outputting the additional keyword; and
receiving input from a user indicating whether to include or exclude some of the results from the result set based on the additional keyword.

8. The method of claim 1, further comprising the steps of:
identifying a second additional keyword missing from the query that would narrow the result set; and
narrowing the result set based upon the second additional keyword.

9. The method of claim 1, further comprising the step of:
identifying a first plurality of keywords omitted from the query wherein inclusion of each of the first plurality of keywords in the query would result in narrowing the result set by a respective first percentage.

10. The method of claim 9, further comprising the steps of:
ranking the first plurality of keywords based at least in part on the proximity of the respective first percentage to 50%; and
outputting a ranked list of the first plurality of keywords.

11. The method of claim 1, wherein each of the results comprises a web page.

12. The method of claim 11, wherein each web page identified by the result set is indexed by a search engine.

13. The method of claim 1, further comprising the steps of:
receiving instructions to either include or exclude results matching the additional keyword; and
formulating a new search query based on the received instructions;
wherein narrowing the result set includes executing the new search query to generate a new result set.

14. A computer-implemented method for performing a search, the method comprising the steps of:
receiving a search query comprising one or more keywords;
returning search results by executing the search query, the search results identifying a plurality of web pages;
analyzing the search results to identify an additional keyword missing from the one or more keywords; and
narrowing the number of web pages identified by search results based on the additional keyword.

15. The method of claim 14, further comprising the step of:
removing from the search results those web pages matching the additional keyword.

16. The method of claim 14, further comprising the step of:
removing from the search results those web pages not matching the additional keyword.

17. The method of claim 14, wherein the additional keyword matches a first portion of the web pages and does not match a remaining portion of the web pages.

18. The method of claim 14, wherein the step of analyzing further includes the step of:
determining if including the additional keyword in the search query would eliminate a first portion of the web pages from the search results.

19. The method of claim 18, wherein the first portion is substantially between 40% to 60%.

20. The method of claim 14, wherein the step of analyzing further includes the step of:
determining if omitting, from the search results, web pages that match the additional keyword would eliminate a first portion of the web pages from the search results.

21. The method of claim 20, wherein the first portion is substantially between 40% to 60%.

22. The method of claim 14, wherein the step of analyzing further includes the step of:
determining if the additional keyword has a historical relationship with another keyword in the search query.

23. An apparatus comprising:
at least one microprocessor;
a memory coupled with the at least one microprocessor; and
program code residing in the memory and executed by the at least one processor, the program code configured to:
in response to a query that includes one or more keywords, generate a result set identifying a plurality of results that match the query;
analyze the result set to identify at least one additional keyword missing from the query that would narrow the result set; and
narrow the result set based upon the additional keyword.

24. The apparatus of claim 23, wherein the program code is further configured to narrow the result set by removing from the result set those results matching the additional keyword.

25. The apparatus of claim 23, wherein the program code is further configured to narrow the result set by removing from the result set those results not matching the additional keyword.

26. The apparatus of claim 23, wherein the additional keyword matches a first portion of the results and does not match a second portion of the results.

27. The apparatus of claim 23, wherein the program code is further configured to output at least a portion of the result set, output the additional keyword, and receive input from a user indicating whether to include or exclude some of the results from the result set based on the additional keyword.

28. The apparatus of claim 23, wherein the program code is further configured to identify a first plurality of keywords omitted from the query wherein inclusion of each of the first plurality of keywords in the query would result in narrowing the result set by a respective first percentage.

29. The apparatus of claim 28, wherein the program code is further configured to rank the first plurality of keywords based at least in part on the proximity of the respective first percentage to 50%, and to output a ranked list of the first plurality of keywords.

30. The apparatus of claim 23, wherein each of the results comprises a web page.

31. The apparatus of claim 30, wherein each web page identified in the result set is indexed by a search engine.

32. The apparatus of claim 23, wherein the program code is further configured to receive instructions to either include or exclude results matching the additional keyword, and to formulate a new search query based on the received instructions, and wherein the program code is configured to narrow the result set by executing the new search query to generate a new result set.

33. A program product, comprising:
program code configured upon execution to:
in response to a query that includes one or more keywords, generate a result set identifying a plurality of results that match the query;
analyze the result set to identify at least one additional keyword missing from the query that would narrow the result set; and
narrow the result set based upon the additional keyword; and a computer readable signal bearing medium bearing the program code.
